(19) United States
(12) Patent Application Publication
(10) Pub. No.: US 2009/0229698 A1
(43) Pub. Date: Sep. 17, 2009

(54) Apparatus for Driving a Spiral Coil into a Document Ring

(76) Inventor: Chou-Chih CHIANG, Taichung City (TW)

Correspondence Address: HDLS Patent & Trademark Services, P.O. BOX 220746, CHANTILLY, VA, 20153-0746, US

(21) Appl. No.: 12/046,405

(22) Filed: Mar. 11, 2008

(51) Int. Cl. B42B 5/12

(52) U.S. Cl. 140/92.3; 412/39

(57) ABSTRACT

An apparatus for driving a spiral coil into a document ring synchronously adjusts a winding and a longitudinal size thereof, so that a document is convenient for arranging. The apparatus includes a winding bearing set, an adjustment module, and a longitudinal cut module. The winding bearing set has a driving shaft for driving the spiral coil into the holes drilled on the document, and an auxiliary shaft for supporting the spiral coil. The longitudinal cut module is adapted to cut the spiral coil at an end thereof according to an external diameter of the spiral coil, and to synchronously bend the spiral coil to prevent the spiral coil from departing from the document. The adjustment module synchronously adjusts a distance between the auxiliary shaft and the driving shaft, and a position of the longitudinal cut module. Therefore the winding bearing set and the longitudinal cut module synchronously meet spiral coil with the same diameter. By the aforementioned design, an objective of conveniently assembling spiral coil into the holes drilled on the document is achieved.

### BACKGROUND OF THE INVENTION

1. Field of the Invention

The present invention relates to a technical filed of collecting and arranging documents. Specially, the present invention relates to an apparatus for synchronously adjusting the length needed to be cut and the external diameter of a spiral coil to drive the spiral coil into a document ring to enhance convenience of utility.

2. Descriptions of the Related Art

Generally, bulk papers, when collecting and arranging, are collected by paper binder, clipper, glue, blue strip, or spiral coil. But the paper binder, clipper, and glue are easy to be peeled off to miss documents. And the book tightly bound is not convenient for reading. Thus using the spiral coil for collecting the documents with holes drilled on the documents is good at difficult to be peeled, and convenient for reading.

Conventionally, driving the spiral coil into the document is made by hands to drive the spiral coil ring by ring into the holes drilled on the document, and then to cut the extension ends of the spiral coil and to bend the spiral coil for preventing the spiral from departing from the document. However, the aforementioned manual operation is disadvantaged at low speed, low efficiency. After driving the spiral coil, the length needed to be cut varies with the external diameter of the spiral coil. When the length needed to be cut is too short, it cannot prevent the spiral coil from departing from the document, and when the length needed to be cut is too long, the bended portion is not convenient for later use. The manual operations cannot be done by one action and rely on experience of the operator to get better quality of work. Thus, how to drive the spiral coil with more convenient, and more efficient solution and enhance quality of work is a long-term need of users.

The inventor of the present invention is experienced in RD and manufacturing of the related industry. In view of the operations relating to the spiral coil and the document, the inventor was inclined to improve it, and finally succeeded in developing An apparatus for driving a spiral coil into a document ring to enhance the convenience and efficiency of work.

### SUMMARY OF THE INVENTION

Therefore, the primary objective of the invention is to provide an apparatus for driving a spiral coil into a document ring. Thereby a spiral distance, and a position of the longitudinal cut module can be adjusted according to an external diameter of the spiral coil to enhance convenience of utility.

The objective and performance of the present invention is achieved by the following technologies. The present invention is configured to drive a spiral coil into the holes drilled on the document. The apparatus comprises:

a base;

a winding bearing set, being set on the base, the winding bearing set comprising a driving shaft and an auxiliary shaft, wherein the driving shaft is driven by a driving device set on the base, and the auxiliary shaft is controlled by an adjustment module set on the base to adjust distance between the auxiliary shaft and the driving shaft to make the driving shaft and the auxiliary shaft synchronously prop up an external edge of the spiral coil;

a longitudinal cut module, being set on the base, the longitudinal cut module being controlled by the adjustment module to cut the spiral coil at an end thereof with a length according to an external diameter of the spiral coil, and the longitudinal cut module comprising a bending base for bending the spiral coil, and a longitudinal cut base for cutting the spiral coil.

Thereby, by the performance of the aforementioned technologies, the present invention is able to drive the spiral coil into the holes drilled on the document by the driving shaft and the auxiliary shaft, and further cut the spiral coil at an end thereof according to an external diameter of the spiral coil by the longitudinal cut module, then synchronously bend the spiral coil to prevent the spiral coil from departing from the document. The adjustment module synchronously adjusts a distance between the auxiliary shaft and the driving shaft, and a position of the longitudinal cut module, therefore the winding bearing set and the longitudinal cut module synchronously meet spiral coil with the same diameter, and the spiral coil is convenient to be driven into the holes drilled on the document to enhance supplementary value of products and enhance competition superiority and economic benefit.

Preferred embodiments are illustrated hereinafter with figures and part numbers to further describe the present invention. Thus the examiner can clearly understand the present invention. However, the preferred embodiments described as below are merely applied to explain but not intended to limit the present invention. Any modification or change of the present invention within the creation of the present invention shall be rendered as within the scope of protection claimed by the present invention.

### BRIEF DESCRIPTION OF THE DRAWINGS

The drawings disclose an illustrative embodiment of the present invention, which serves to exemplify the various advantages and objects hereof, and are as follows:

FIG. 1 illustrates an outline diagram of the apparatus of the present invention;

FIG. 2 illustrates a first internal configuration of the present invention to explain the internal situation of the apparatus without a lid;

FIG. 3 illustrates a second internal configuration of the present invention to explain the internal situation of the apparatus without a lid in another view angle;

FIG. 4 illustrates a third internal configuration of the present invention to explain an adjustment module and a longitudinal cut module of the apparatus;

FIG. 5 illustrates a fourth internal configuration of the present invention to explain the relation of the adjustment module and the longitudinal cut module;

FIG. 6 is a diagram of an internal cross-section view of apparatus of the present invention to illustrate the operational relation of the adjustment module, the auxiliary axial module, and the longitudinal cut module;

FIG. 7 illustrates an outline diagram of the longitudinal cut module of the apparatus of the present invention to explain configuration of the longitudinal cut module and the relation therein;

FIG. 8 illustrates a lateral view of the longitudinal cut module of the apparatus of the present invention;

FIG. 9 illustrates a cross-section view of the longitudinal cut module along the A-A line in FIG. 8 to further explain configuration of the longitudinal cut module;

FIG. 10 illustrates a lateral view of the apparatus of the present invention to show operational relation of the longitudinal cut module;

FIG. 11 illustrates a top view of the longitudinal cut module of the apparatus of the present invention;

FIG. 12 illustrates a top view of operating the apparatus of the present invention to demonstrate operation of driving a larger spiral coil;

FIG. 13 illustrates a diagram of operating the apparatus of the present invention to demonstrate operation of cut and bend the spiral coil; and

FIG. 14 illustrates another top view of operating the apparatus of the present invention to demonstrate operation of driving a smaller spiral coil.

### DESCRIPTION OF THE PREFERRED EMBODIMENT

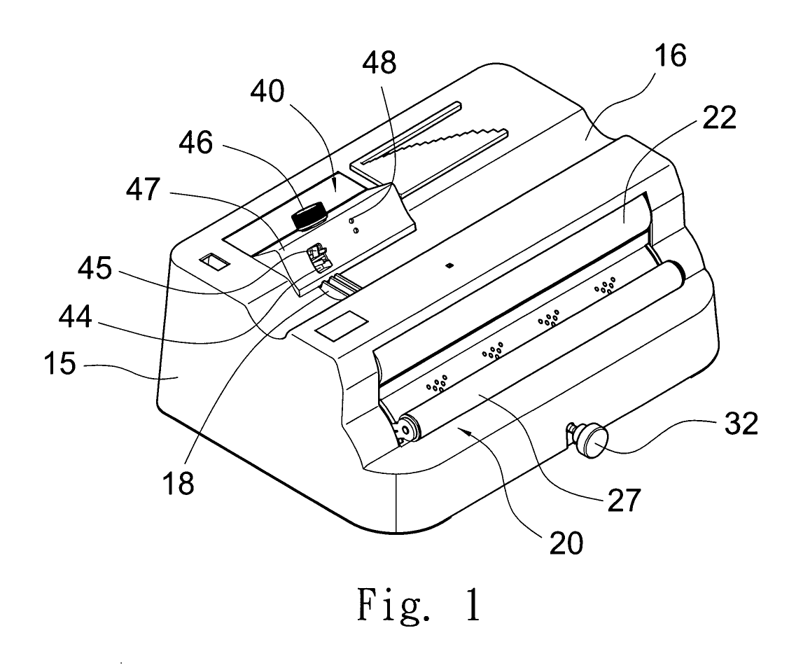

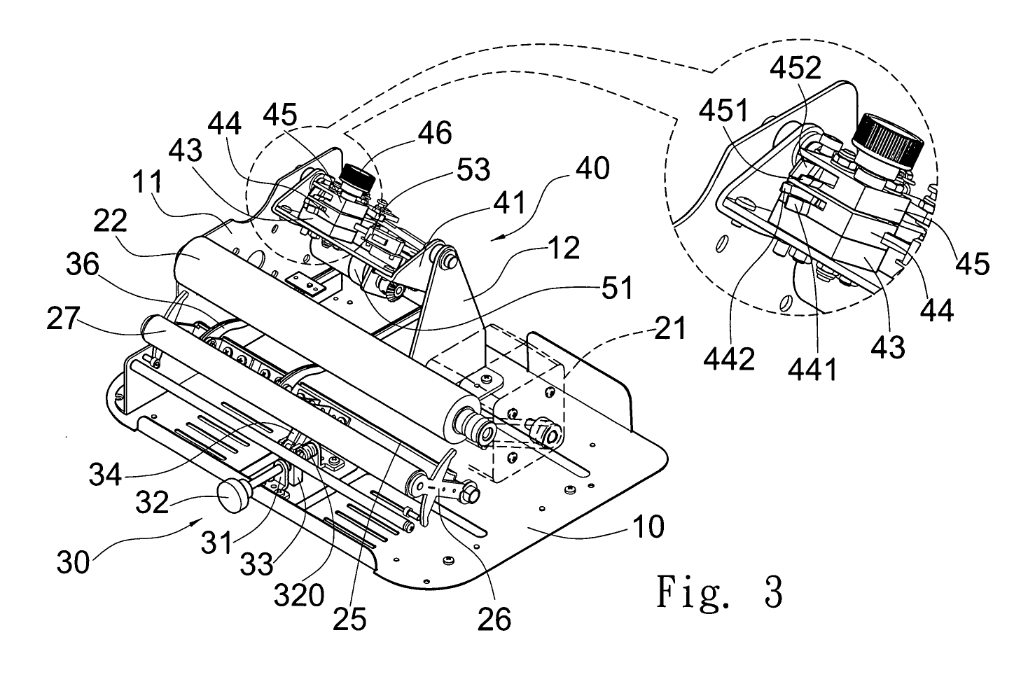

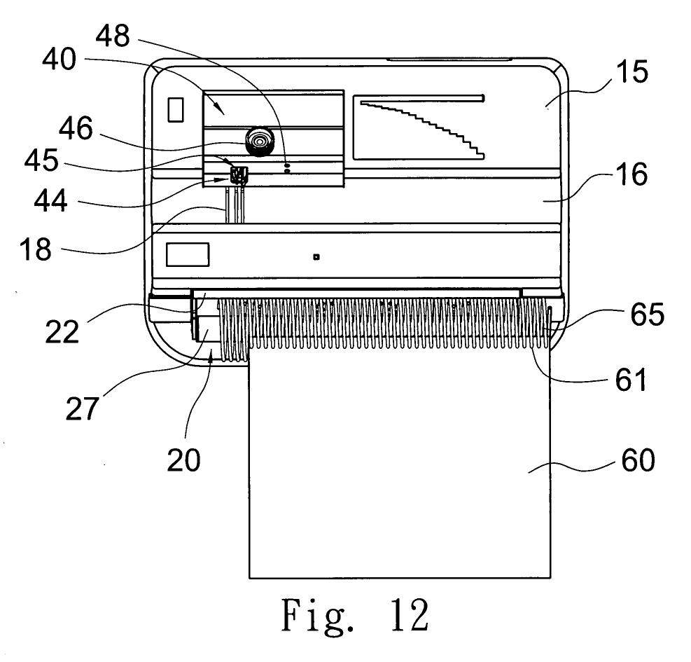

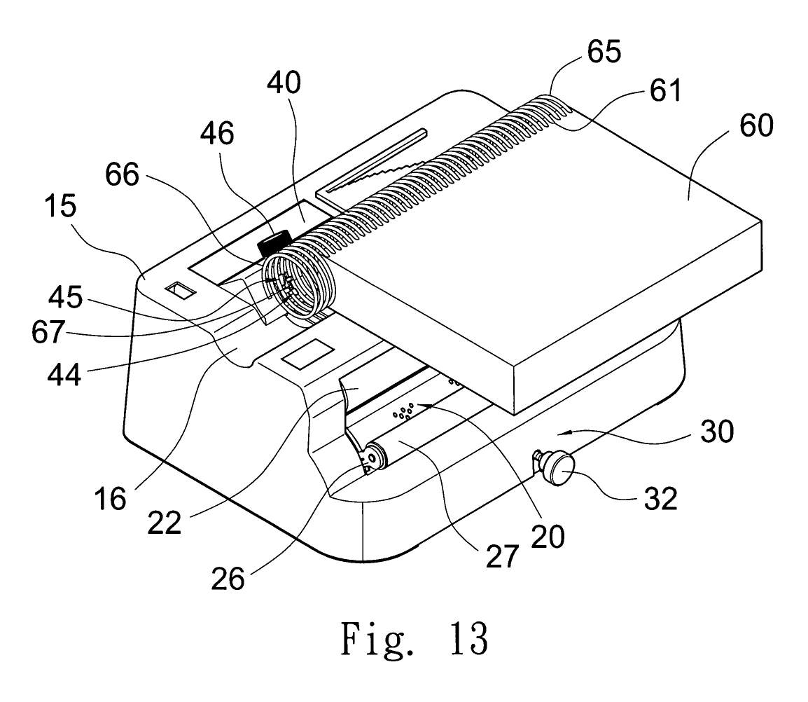

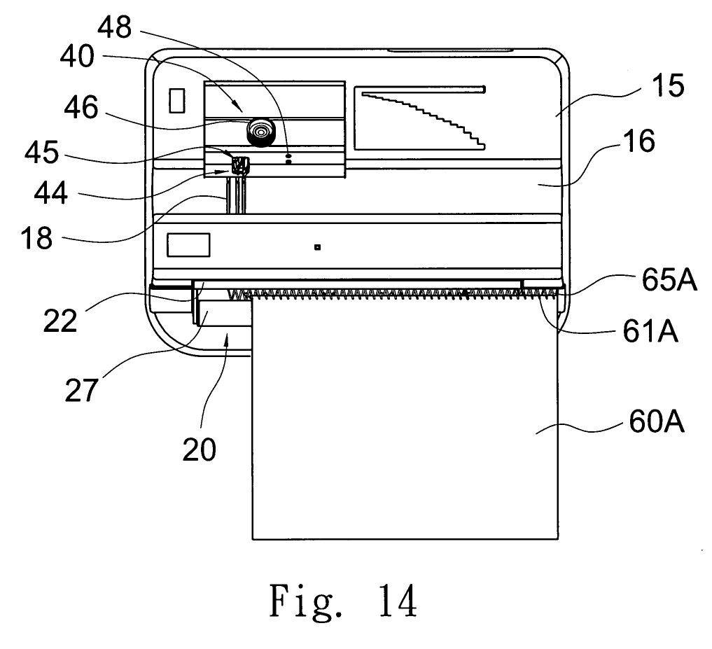

The prevent invention is an apparatus for driving a spiral coil into a document ring. Refer to FIGS. 1-3, the apparatus comprises a winding bearing set (20) set on a base (10), an adjustment module (30), and a longitudinal cut module (40), wherein the winding bearing set (20) is configured to drive the spiral coil (65) into holes (61) drilled on the document (60) (As shown in FIG. 12 and FIG. 14), and the longitudinal cut module (40) is configured to cut and bend the spiral coil (65) at two ends thereof. (As shown in FIG. 13)

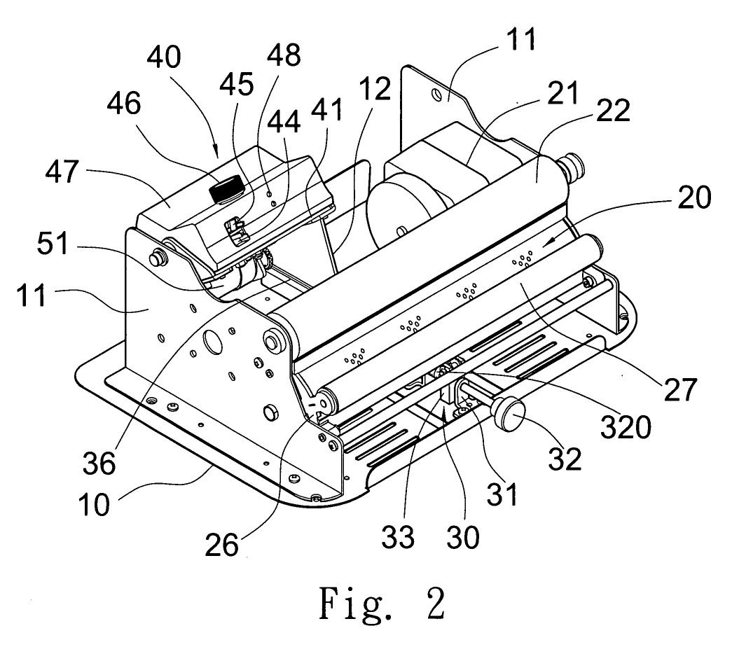

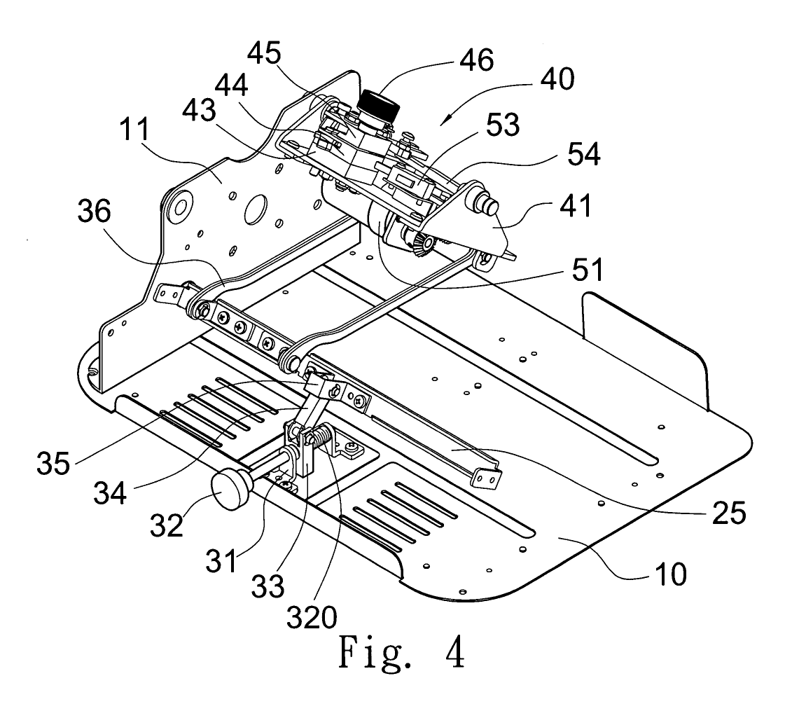

Detailed configuration of the preferred embodiment of the present invention is illustrated in FIGS. 2-5. The base (10) is set with two lateral plates (11) located at each side of the base (10) for fixing the winding bearing set (20), the base (10) is set with a partition (12) between the two plates (11), and the longitudinal cut module (40) is set between upper edges of the partition (12) and the lateral plates (11). Meanwhile the base (10) is covered with a lid (15) partially exposing the winding bearing set (20) and the longitudinal cut module (40) (as shown in FIG. 12 and FIG. 13), the lid (15) is formed with a ditch (16) corresponding to the longitudinal cut module (40) for containing the spiral coil (65), and the ditch (16) is formed with at least one of convex flakes (18) for fixing position of the spiral coil (65).

The winding bearing set (20) comprises a driving shaft (22) and an auxiliary shaft (27) for adjusting relative distance. The winding bearing set (20) is set with a driving device (21) on the lateral plate (11) of the base (10) for operating the driving shaft (22), and the two lateral plate (11) are set with a rotation axial base (25) on bottom portion corresponding to the driving shaft (22). The rotation axial base (25) is set with two arms (26) located at two ends thereof, and the auxiliary shaft (27) is pivoted between the two arms (26) for being able to adjust the distance between the auxiliary shaft (27) and the driving shaft (22) by operation of the rotation axial base (25) and the arms (26) in accordance with spiral coils (65) with different external diameters. (As shown in FIG. 12 and FIG. 14)

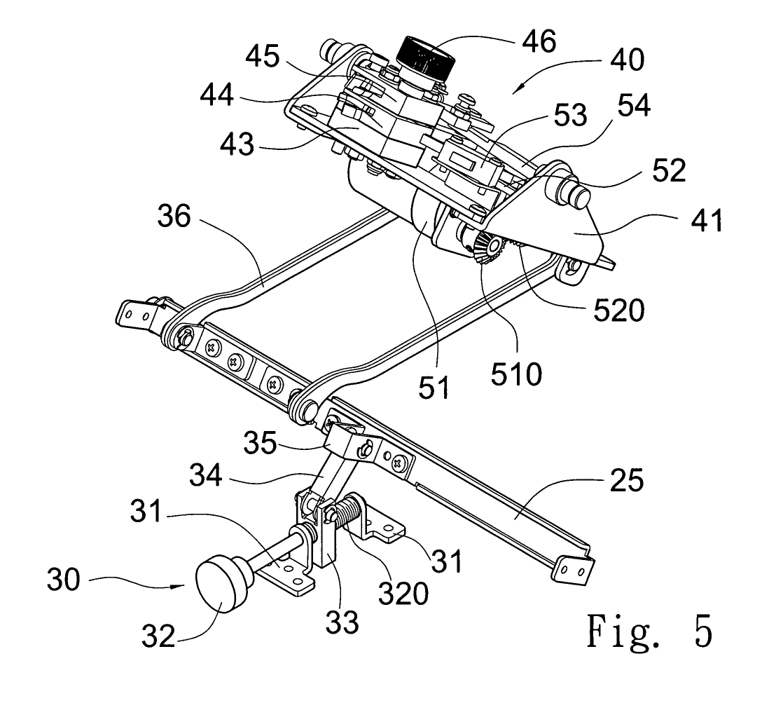

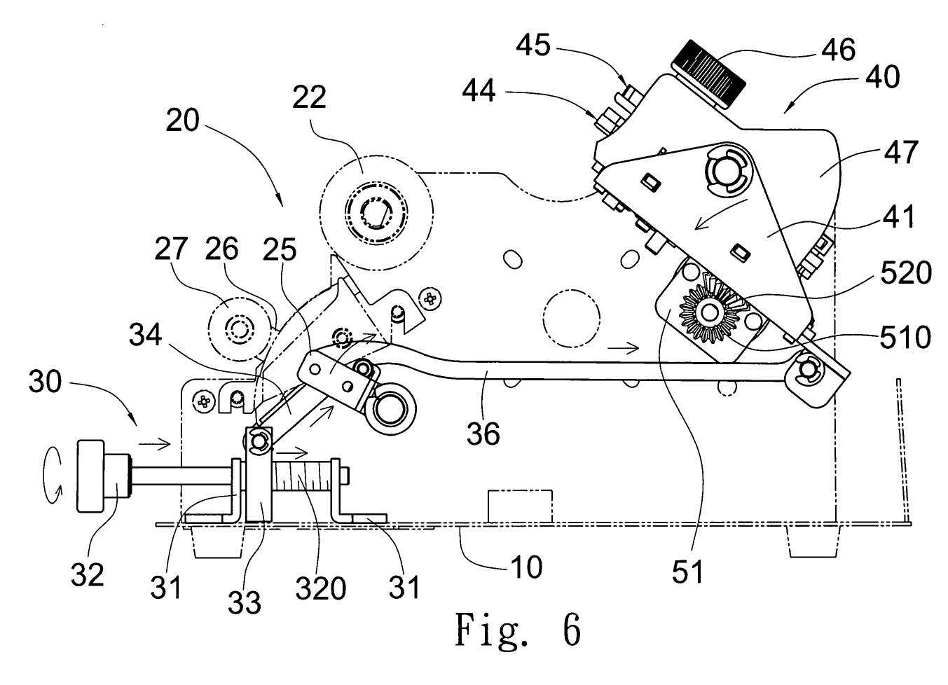

Refer to FIG. 5, the adjustment of the auxiliary shaft (27) is achieved by the adjustment module (30) set on the base (10). The adjustment module (30) is set with two axial bases (31) on the base (10), and an adjustment pole (32) is pivoted between the two axial bases (31) and perpendicularly across the auxiliary shaft (27), the adjustment pole (32) is formed with a screw portion (320) between the two bases (31), the screw portion (320) of the adjustment pole (32) is set with a moving base (33), the moving base (33) is controlled to move forward and backward relative to the screw portion (320) by the rotation of the adjustment pole (32), and a linking pole (34) is pivoted to the moving base (33), another end of the linking pole (34) is pivoted to a pivot hinge (35) fixed at the rotation axial base (25) for rotating the rotation axial base (25) through the linking pole (34) when the moving base (33) moves forward and backward. (As shown in FIG. 6) At least one of linkage poles (36) is pivoted to the rotation axial base (25), and another end of the linkage poles (36) is pivoted to the longitudinal cut module (40) for synchronously operating the longitudinal cut module (40) when the rotation axial base (25) rotates. (as shown in FIG. 6) When the adjustment module (30) decreases the distance between the auxiliary shaft (27) and the driving shaft (22), the length to be cut by the longitudinal cut module (40) is synchronously shrunk.

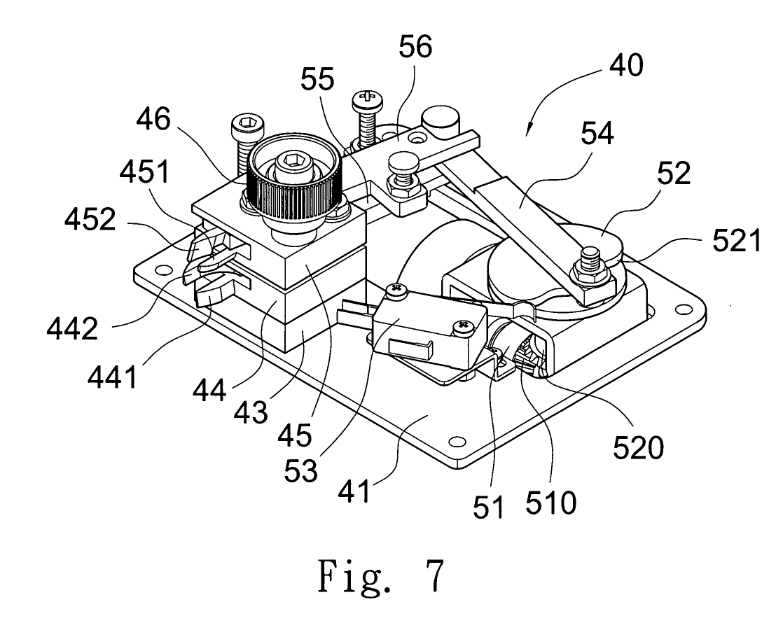

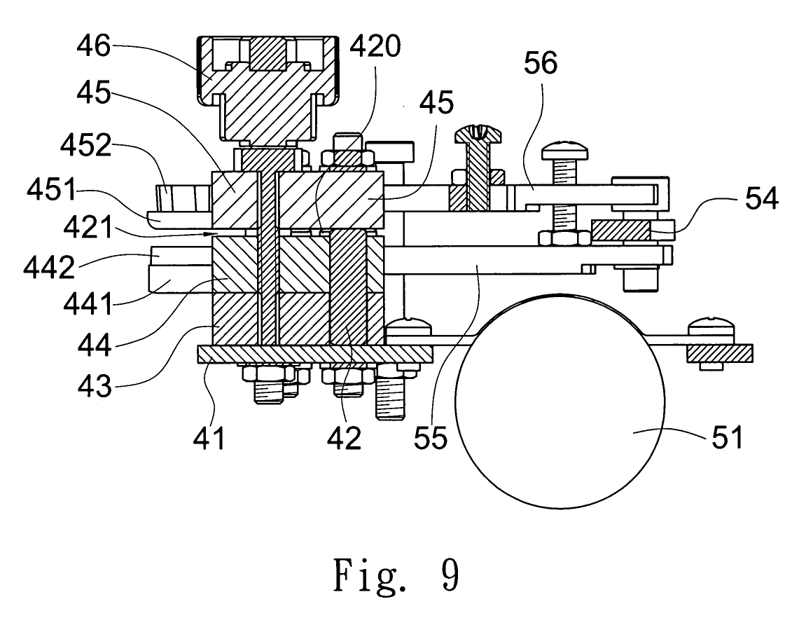

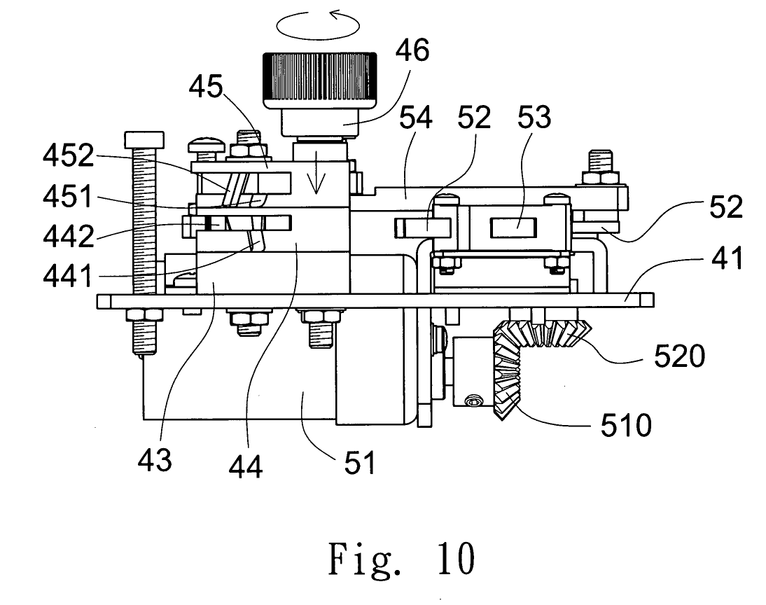

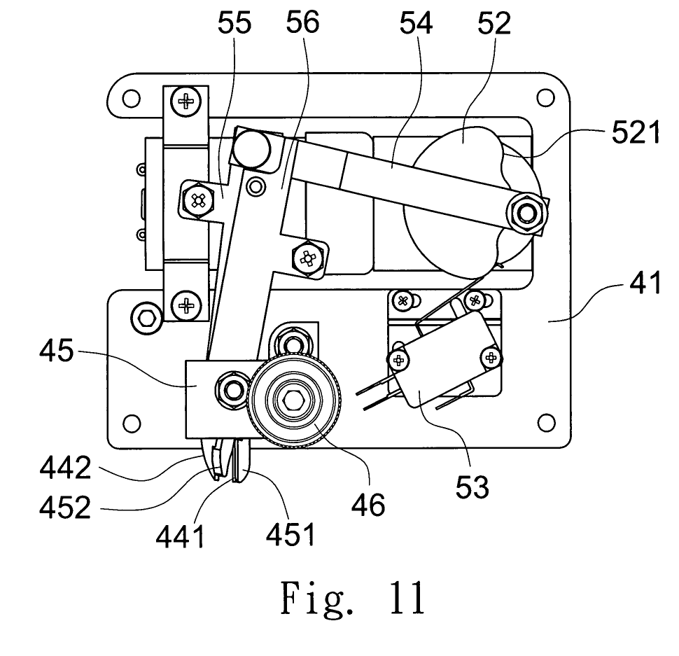

Refer to FIGS. 6-11, the longitudinal cut module (40) comprises a mechanic base (40) being pivoted to one of the lateral plate (11) of the base (10) and the partition (12), and the mechanic base (41) is bottom-up set with a buffer (43), a bending base (44), and a longitudinal cut base (45) along with a lock pole (42). A spacer (420) is set between the bending base (44) and the longitudinal cut base (45) to form a gap (421) there between for the bending base (44) to be fine tuned, and a rotation pole (46) is pivoted to the spacer (420) and the longitudinal cut base (45), and the bending base (44) is screwed to the rotation pole (46) (or the longitudinal cut base (45) is screwed to the rotation pole (45)) and able to be fine tuned when rotating the rotation pole (45).(as shown in FIG. 9 and FIG. 10) The bending base (44) has a stationary jaw (441) and a movable jaw (442) for oppositely bending the spiral coil (65) (as shown in FIGS. 12-13), the longitudinal cut base (45) has a stationary blade (451) and a movable blade (452) for oppositely cutting the spiral coil (65). The longitudinal cut module (40) is set with a shell (47) for covering other devices on the mechanic base (41), and the shell (47) is set with a detection device (48) for preventing the bending base (44) and the longitudinal cut base (45) from randomly moving when the document (60) is not fixed.

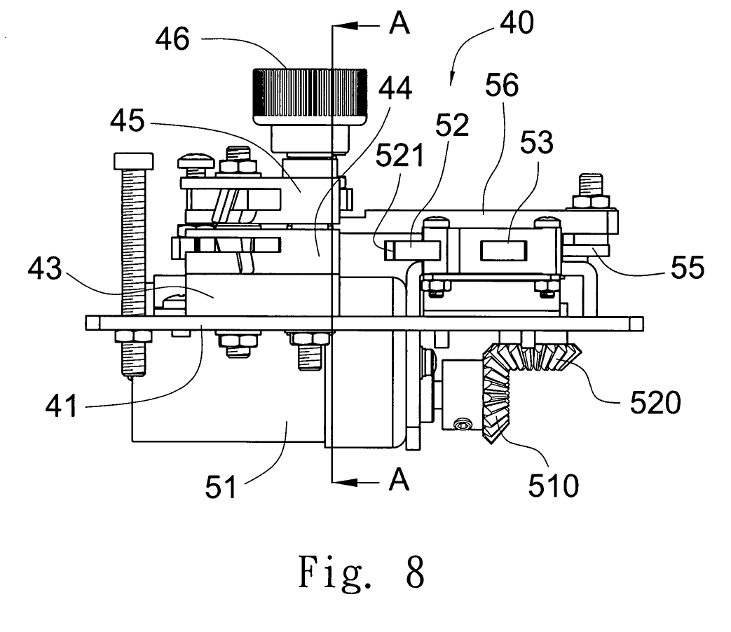

Refer to FIGS. 8-10, the mechanic base (41) is set with a driving device (51) on the bottom surface. The driving device (51) has a umbrella gear wheel (510). The mechanic base (41) is set with a cam (52) controlled by the driving device (51) on the top surface. The cam (52) has another umbrella gear wheel (520) in mesh with the umbrella gear wheel (510). The cam (52) is surrounded by a curved leading edge (521), and the top surface of the mechanic base (51) is set with a fine moving switch (53) located on the cam (52) side corresponding to the curved leading edge (521) for controlling turn on/off of the driving device (51). A crank (54) is eccentrically pivoted to the cam (52), a first driving pole (55) and a second driving pole (56) are respectively pivoted to two surfaces of another end of the crank (54) for operating the movable jaw (442) of the bending base (44) and the movable blade (452) of the longitudinal cut base (45).

Thereby, an apparatus for driving a spiral coil (65) into holes drilled on the document (60) is achieved.

By the aforementioned configuration, operation of the present invention is illustrated in FIGS. 1, 6, and 12-14. The user first adjusts the distance of the winding bearing set (20) according to the external diameter of the spiral coil (65)(65A). Detailed, the user rotates the adjustment pole (32) of the adjustment module (30) to make the adjustment pole (32) drive the moving base (33) to move, then to rotate the rotation axial base (25) through the linking pole (34) to make the auxiliary shaft (27) on the rotation axial base (25) move opposite to the driving shaft (22). Therefore the distance between the driving shaft (22) and the auxiliary shaft (27) is adjusted, and the spiral coil (65)(65A) synchronously props up the driving shaft (22) and the auxiliary shaft (27). The driving shaft (22) then efficiently drives the spiral coil (65)(65A) to make the spiral coil (65)(65A) completely into the holes (61)(61A) drilled on the corresponding documents (61)(61A).

Refer to FIG. 6, when the adjustment pole (32) of the adjustment module (30) operates the moving base (33) to rotate the rotation axial base (25), it can synchronously operate the mechanic base (41) of the longitudinal cut module (40) by the linkage pole (36) pivoted to the rotation axial base (25), to determined the length needed to be cut of the extension portion (66) according to the external diameter of the corresponding spiral coil (65)(65A). When the documents (60)(60A) with spiral coils (65)(65A) are placed in the ditch (16) of the lid (15), the driving device (51) of the longitudinal cut module (40) is activated to rotate the cam (52) on the mechanic base (41), and synchronously operates the first and the second driving poles (55)(56) via the crank (54) eccentrically pivoted to the cam (52) to respectively operate the movable blade (452) of the longitudinal cut base (45), relative to the stationary blade (451), to cut the extension portion (66) of the spiral coils (65)(65A), and to operate the movable jaw (442) of the bending base (44), relative to the stationary jaw (441), to bend the extension portion (66) of the spiral coils (65)(65A) as a bended portion (67) to prevent the spiral coil (65)(65A) from departing from the document (60)(60A).

The user can rotate the rotation pole (46) of the longitudinal cut module (40) to operate the bending base (44) screwed on the rotation pole (46) for fine tuning the distance between the bending base (44) and the longitudinal cut base (45) and fine tuning the length of the bended portion (67).

The present invention is able to adjust the distance between the driving shaft (22) and the auxiliary shaft (27) of the winding bearing set (20) by the adjustment module (30) to meet the spiral coil (65) with different external diameter. The longitudinal cut module (40) changes the length needed to be cut according to the external diameter of the spiral coil to make the winding bearing set and the longitudinal cut module synchronously meet spiral coil with the same diameter. The spiral coil is convenient to be driven into the holes drilled on the document to enhance supplementary value of products and enhance competition superiority and economic benefit

To conclude, the present invention is a very good creation, and it or similar products or publications in the same technical field cannot be found. The present invention also improves the performance. Thus, the present invention conforms to rules of novelty and non-obviousness of patent examination, and the present invention shall be allowed as soon as possible.

What is claimed is:

1. An apparatus for driving a spiral coil into a document ring, being configured to drive the spiral coil into the holes drilled on the document, the apparatus comprising:
a base;
a winding bearing set, being set on the base, the winding bearing set comprising a driving shaft and an auxiliary shaft, wherein the driving shaft is driven by a driving device, and the auxiliary shaft is controlled by an adjustment module set on the base to adjust distance between the auxiliary shaft and the driving shaft to make the driving shaft and the auxiliary shaft synchronously prop up an external edge of the spiral coil; and
a longitudinal cut module, being set on the base, the longitudinal cut module being controlled by the adjustment module to cut the spiral coil at an end thereof with a length according to an external diameter of the spiral coil, and the longitudinal cut module comprising a bending base for bending the spiral coil, and a longitudinal cut base for cutting the spiral coil.

2. The apparatus for driving a spiral coil into a document ring as claimed in claim 1, wherein the base is set with two lateral plates located at each side of the base, the winding bearing set is pivoted between the two lateral plates, the base is set with a partition between the two plates, and the longitudinal cut module is set between upper edges of the partition and the lateral plates.

3. The apparatus for driving a spiral coil into a document ring as claimed in claim 1, wherein the base is covered with a lid partially exposing the winding bearing set and the longitudinal cut module.

4. The apparatus for driving a spiral coil into a document ring as claimed in claim 3, wherein the lid is formed with a ditch corresponding to the longitudinal cut module for containing the spiral coil, and the ditch is formed with at least one of convex flakes for fixing position of the spiral coil.

5. The apparatus for driving a spiral coil into a document ring as claimed in claim 1, wherein the winding bearing set is set with a rotation axial base on the base with two arms located at two ends thereof and being configured to synchronously rotating, and the auxiliary shaft is pivoted between the two arms for being able to adjust the distance between the auxiliary shaft and the driving shaft by operation of the rotation axial base and the arms in accordance with spiral coils with different external diameters.

6. The apparatus for driving a spiral coil into a document ring as claimed in claims 1, wherein the adjustment module is set with two axial bases on the base, and an adjustment pole is pivoted between the two axial bases and perpendicularly across the auxiliary shaft, the adjustment pole is formed with a screw portion between the two axial bases, the screw portion of the adjustment pole is set with a moving base, the moving base is controlled to move forward and backward relative to the screw portion by the rotation of the adjustment pole, and a linking pole is pivoted to the moving base, another end of the linking pole is pivoted to a pivot hinge fixed at the rotation axial base for rotating the rotation axial base through the linking pole when the moving base moves forward and backward.

7. The apparatus for driving a spiral coil into a document ring as claimed in claims 5, wherein the adjustment module is set with two axial bases on the base, and an adjustment pole is pivoted between the two axial bases and perpendicularly across the auxiliary shaft, the adjustment pole is formed with a screw portion between the two axial bases, the screw portion of the adjustment pole is set with a moving base, the moving base is controlled to move forward and backward relative to the screw portion by the rotation of the adjustment pole, and a linking pole is pivoted to the moving base, another end of the linking pole is pivoted to a pivot hinge fixed at the rotation axial base for rotating the rotation axial base through the linking pole when the moving base moves forward and backward.

8. The apparatus for driving a spiral coil into a document ring as claimed in claim 6, wherein at least one of linkage poles is pivoted to the adjustment module between the rotation axial base and the mechanic base of the longitudinal cut module for synchronously operating the longitudinal cut module when the rotation axial base rotates.

9. The apparatus for driving a spiral coil into a document ring as claimed in claim 1, wherein the longitudinal cut module is bottom-up set with a buffer, a bending base, and a longitudinal cut base along with a lock pole on a mechanic base thereof, the bending base has a stationary jaw and a movable jaw, the longitudinal cut base has a stationary blade and a movable blade, and the base is set with a driving device on a bottom surface thereof, the base is set with a cam controlled by the driving device on a top surface of the mechanic base, a crank is eccentrically pivoted to the cam, a first driving pole and a second driving pole are respectively pivoted to two surfaces of another end of the crank for operating the movable jaw of the bending base and the movable blade of the longitudinal cut base.

10. The apparatus for driving a spiral coil into a document ring as claimed in claims 1, wherein the longitudinal cut module is set with a shell on the mechanic base for covering other devices on the base, and the shell is set with a detection device for preventing the bending base and the longitudinal cut base from randomly moving when the document is not fixed.

11. The apparatus for driving a spiral coil into a document ring as claimed in claim 9, wherein the driving device of the longitudinal cut module has a umbrella gear wheel, and the cam has another umbrella gear wheel in mesh with the umbrella gear wheel of the longitudinal cut module.

12. The apparatus for driving a spiral coil into a document ring as claimed in claim 9, wherein, between the bending base and the longitudinal cut base, a gap being able to be fine tuned is formed, and a rotation pole is pivoted to the bending base and the longitudinal cut base, and the bending base and the longitudinal cut base are screwed to the rotation pole and able to be fine tuned when rotating the rotation pole.

13. The apparatus for driving a spiral coil into a document ring as claimed in claim 9, wherein the cam is surrounded by a curved leading edge, and the top surface of the mechanic base is set with a fine moving switch located on the cam side corresponding to the curved leading edge for controlling turn on/off of the driving device.

14. An apparatus for driving a spiral coil into a document ring, being configured to drive the spiral coil into the holes drilled on the document, the apparatus comprising:
a base;
a longitudinal cut module, being set on the base, the longitudinal cut module comprising a bending base for bending the spiral coil and a longitudinal cut base for cutting the spiral coil.

15. The apparatus for driving a spiral coil into a document ring as claimed in claim 14, wherein the longitudinal cut module is bottom-up set with a bending base, and a longitudinal cut base along with a lock pole on a mechanic base thereof, the bending base has a stationary jaw and a movable jaw, the longitudinal cut base has a stationary blade and a movable blade.

16. The apparatus for driving a spiral coil into a document ring as claimed in claim 15, wherein the mechanic base is set with a driving device on a bottom surface thereof, the mechanic base is set with a cam controlled by the driving device on a top surface thereof, a crank is eccentrically pivoted to the cam, a first driving pole and a second driving pole are respectively pivoted to two surfaces of another end of the crank for operating the movable jaw of the bending base and the movable blade of the longitudinal cut base.

17. The apparatus for driving a spiral coil into a document ring as claimed in claim 15, wherein the driving device of the longitudinal cut module has a umbrella gear wheel, and the cam has another umbrella gear wheel in mesh with the umbrella gear wheel of the longitudinal cut module.

18. The apparatus for driving a spiral coil into a document ring as claimed in claim 15, wherein a spacer is set between the bending base and the longitudinal cut base to form a gap therebetween for the bending base to be fine tuned, and a rotation pole is pivoted to the spacer and the longitudinal cut base, and the bending base is screwed to the rotation pole and able to be fine tuned when rotating the rotation pole.

19. The apparatus for driving a spiral coil into a document ring as claimed in claim 15, wherein the cam is surrounded by a curved leading edge, and the top surface of the mechanic base is set with a fine moving switch located on the cam side corresponding to the curved leading edge for controlling turn on/off of the driving device.
